(19) United States
(12) Patent Application Publication
(10) Pub. No.: US 2020/0204375 A1
(43) Pub. Date: Jun. 25, 2020

(54) DISTRIBUTED LEDGERS FOR SHARING DATA IN THE AERONAUTICAL FIELD

(71) Applicant: THALES, Courbevoie (FR)

(72) Inventors: François COULMEAU, TOULOUSE (FR); Guillaume PABIA, MERIGNAC (FR)

(21) Appl. No.: 16/691,077

(22) Filed: Nov. 21, 2019

(30) Foreign Application Priority Data
Dec. 21, 2018 (FR) 1873873

(51) Int. Cl. H04L 9/32; H04L 9/06; H04L 9/08; G06F 16/18; G07C 5/08; G06N 3/04; G06N 20/10

(52) U.S. Cl. CPC H04L 9/3242; H04L 9/0637; H04L 9/088; G06F 16/1865; H04L 2209/38; G06N 3/04; G06N 20/10; H04L 2209/84; G07C 5/0841

(57) ABSTRACT

Systems and computer-implemented methods for sharing aeronautical data, include steps of: maintaining a private blockchain, the blockchain involving a plurality of predefined parties; conditionally communicating aeronautical data, in response to a request by one party, via a mechanism for controlling the exchanges, the data being collected beforehand from aeronautical computers, e.g. on-board flight management systems (FMS) of aircraft. Extensions in particular describe the use: of mechanisms for providing compensation or remuneration for and managing access rights and/or licenses to use; smart contracts; mechanisms for auctioning or trading datasets; management of avionic and non-avionic data; learning techniques applied to the shared and consolidated data; management of side chains; post-quantum encryption. Software aspects are described.

### CROSS-REFERENCE TO RELATED APPLICATIONS

This application claims priority to foreign French patent application No. FR 1873873, filed on Dec. 21, 2018, the disclosure of which is incorporated by reference in its entirety.

### FIELD OF THE INVENTION

This document relates to the general technical field of information processing. In particular, this document describes systems and methods for sharing data in the aeronautical field, in particular using distributed databases.

### BACKGROUND

The sharing of data between industrial players of a given sector is still an activity where cooperation and rivalry intermix. The reasons to share data often run up against the desire to build a private corpus, for exclusive purposes. Independently of the strategies of industrial players, basically, to extract data of value, it remains advantageous to accumulate large amounts of data (e.g. cross-correlations, correlations, learning, etc.).

Certain technologies, in particular blockchains or distributed ledgers, if they were suitably adapted, could redefine the activity of sharing data and create opportunities with respect to new sharing modalities.

In the complex ecosystem of aeronautics, flight computers produce a large amount of data, which may be of interest to many industrial players (aeroplane manufacturers, OEMs, pilots and airlines, authorities in charge of air traffic control, etc.). The same players also produce very large amounts of data, leading to the creation of data silos that are generally not shared. Because these data are not exploited communally, many opportunities are probably being missed. The data may be enriched and value may be extracted from the silos, using a wide diversity of approaches.

Operators of modest size, who have at their disposal a small number of craft, have a real interest in sharing data, because the algorithms allowing value to be extracted from data require large volumes thereof in order to be precise and reliable. However, most aircraft operators fall within this category (few craft in use), compared to the few large companies that may have at their disposal sufficient datasets to perform the analysis thereof.

At the same time as the data are shared, it is important to be able to ensure their approved origin (authenticity) and compliant transmission (integrity).

Lastly, it is important to find mechanisms that, at least to a certain extent, remunerate contributions fairly, or at the very least sufficiently attractively to motivate sharing. With known approaches, these aspects are resolved non-technically, i.e. generally via contracts (for example with one of more intermediaries or brokers who specify and price the datasets that a supplier must produce for a client).

As regards blockchains (or distributed ledger technology (DLT)) applied to the specific context of aeronautics, everything remains to be done. Publications relating to blockchain are almost exclusively in English and generally appertain to Bitcoin and financial applications. At the end of 2018, the patent literature amounted to only two publications FR3062499 and FR3063406, which are interesting but not relevant to the stated technical problems.

Patent EP3367137 entitled “Systems and methods of gathering and distributing critical weather event information” describes a system for sharing critical meteorological information between a plurality of aeroplanes. A centre on the ground (intermediary) is tasked with managing the requests of the various aeroplanes (clients and suppliers). This solution is satisfactory in certain situations but has limitations with regard to more extensive cooperation. For example, the described examples make provision for the presence of an intermediary, who therefore is an addition to the already complex ecosystem of aeronautics. Moreover, the information is transferred only between aeroplanes; in particular use is not made of the resources (which are however much more numerous) available in the “wider world” (i.e. outside of the regulatory context, e.g. Internet data). The type of database used is not specified. Only meteorological information is considered to be critical; flight-optimization data are for example not considered, even though these data may be of high “value”.

With respect to avionics, the considerable balance of raw information generated by on-board computers in an aircraft (for example) is the exclusive property of the supplier of the computer. Licenses may be agreed, in general between the supplier and user (the manufacturer, assembler, client, a regulating authority) in order to allow the latter to use said information. This model has limitations and could be considerably improved.

### SUMMARY OF THE INVENTION

This document describes systems and computer-implemented methods for sharing aeronautical data, comprising steps of: maintaining a private blockchain, said blockchain involving a plurality of predefined parties; conditionally communicating aeronautical data, in response to a request by one party, via a mechanism for controlling the exchanges, the data being collected beforehand from aeronautical computers, e.g. on-board flight management systems (FMS) of aircraft. Extensions in particular describe the use: of mechanisms for providing compensation or remuneration for and managing access rights and/or licenses to use; smart contracts; mechanisms for auctioning or trading datasets; management of avionic and non-avionic data; learning techniques applied to the shared and consolidated data; management of side chains; post-quantum encryption. Software aspects are described.

In one embodiment, one or more blockchains are used to store and share the data (therefore ensuring their quality (e.g. time-stamping, integrity, consensus validation, etc.). Optionally, the sharing of these data (e.g. transactions) is managed (or permitted or controlled) via one or more smart contracts (e.g. access to the data by the users, rights management, etc.).

Advantageously, the sharing and analysis of aeronautical information are improved. The raw or processed data, for example generated by aeronautical computers in a community of suppliers of computers or users of these computers, are collected in order to extract therefrom enriched information having a technical and/or professional value.

Advantageously, the authenticity and integrity of the manipulated data are guaranteed because of the use of a blockchain.

Advantageously, the exchanges (or contributions) may be monitored, catalogued and tracked clearly and transparently, in such a way that the motivation to share is increased. Data that are “useless” to a given party may be of high value to another party (for example a free slot reserved beforehand for the disembarkation of an aeroplane—and unused—may be bought by another company if the availability information is published).

Advantageously, the sharing of information is encouraged, by design, in addition to being secure.

Advantageously, by implementing exchanging methods according to the invention, use of intermediaries to manage exchanges of data may be avoided or decreased. The concentration of data with a single player (or intermediary) or a few parties (large companies for example) is generally suboptimal because it does not allow a general treatment, easily accessible to all suppliers and users, whatever their size. It biases the access to the data, increases transaction costs, disperses rights, etc. The centralization of data may decrease quantitative and/or qualitative data harvesting through a lack of reciprocity or of interest, or even because of the complexity of access to the data. Subsequently, the teachings or analyses drawn from the data are of lesser quality, to the detriment of the final customers (e.g. user experience, aeronautical safety, etc.). In contrast, the invention allows the capture of data, and thus the quality of the analyses that are derived therefrom (analytics) to be increased. Instead of suboptimal exchanges, the invention allows fluid and transparent exchanges between players, in which the motivation to share is unmistakable, sharing being remunerated and the parties being scored transparently if not predictably, and whatever their size in the industrial community.

According to the invention, each party interested in the aeronautical blockchain is therefore free to concentrate on its field of work and to benefit from positive externalities created by the data belonging to others, which data would otherwise be useless. A party will not, or less often, have to procure, via an intermediary, a converted dataset that does not necessarily correspond to its specific needs (less control in the A.I. sense because dependent on algorithms developed by the intermediary).

In avionics, the application of artificial-intelligence technologies (essentially machine learning) coupled to the massive deployment of connectivity between aircraft and/or the ground allows all these data to be exploited on a massive scale (approach referred to as “big data”) for various and advantageous purposes e.g. improvement of maintenance by analysis of a plurality of sources over time; emergence of value-added services for airline operations, e.g. estimation of delays, of overconsumption of fuel, path optimization, anticipation of flows, of the weather, etc.; improvement of the security and/or safety of flights, for example by analysis of flows and by early detection of anomalies that are latent or difficult to predict a priori; improvement of passenger experience via delivery of targeted services and goods; improvement of mission management when many aircraft, drones for example, are engaged, etc.

New, complementary, additional, recent, or otherwise enriched aeronautical data may be manipulated.

By integrating in a specific way (i.e. a way that is suitable with respect to the issues encountered in the profession of aeronautics), technologies relating to blockchains and to smart contracts, the methods and systems according to the invention allow, ultimately, aeronautical safety to be improved. This safety is of fundamental importance in this industry. Existing aeronautical architectures are very closed (there are few links between systems, because of the fear of corruption of data, of attacks, of systemic risks, etc.); the proposed solution makes it possible to significantly improve the technical management of inter-system data, by increasing the areas of analysis (amount of data) and the quality of the analyses performed.

### BRIEF DESCRIPTION OF THE DRAWINGS

Other features and advantages of the invention will become apparent from the following description and from the appended figures of the drawings, in which:

FIG. 1 illustrates the operation of a blockchain according to the invention;

FIG. 2 illustrates examples of steps of one embodiment of the method according to the invention.

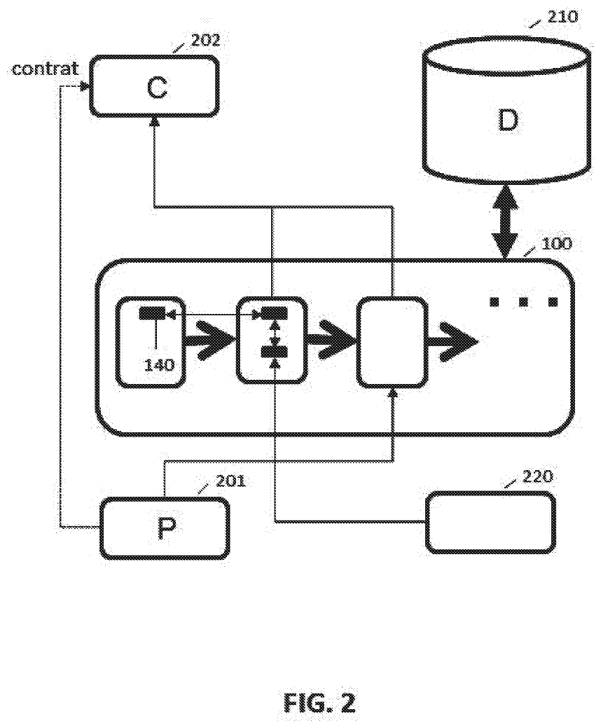

### DETAILED DESCRIPTION

Embodiments of the invention may use blockchains to improve machine learning carried out on big data. These objects or expressions are defined and explained below.

These objects possess intrinsic properties, i.e. properties that are inherent thereto, and are independent of the context of use. However, the constraints or requirements of aeronautics are many and complex. The constraints and compromises of the “trade” are difficult to clearly identify (problem invention) and justify or subjacently structure implementational variations, which otherwise could appear to be arbitrary.

### Big Data

The expression “big data” designates the collection and analysis of data, carried out on a massive scale. This concept is associated with characteristics of technical nature that comprise: volume (e.g. large collections of data, even if they are redundant), variety (e.g. many different sources are used), velocity (e.g. the data are “fresh” or constantly updated in changing or dynamic environments), attesting to a certain veracity (e.g. weak signals that are drowned in noise are not removed and may subsequently be detected or amplified), with a view to achieving, ultimately, a certain value (for example of utility from the technical and/or professional, i.e. business, point of view).

### Machine Learning

Various types of machine learning (automatic learning) are possible. Machine learning is a computational field that uses statistical techniques to give computational systems the ability “to learn” from data (for example, in order to gradually improve the performance of a specific task), without being explicitly programmed to this end.

Automatic learning is advantageous for the detection and recognition of patterns or shapes or trends. It is frequently easier to collect the data (for example data from a video game or from a company) than to explicitly write the program that governs the set in question. In addition, neural networks (hardware embodiment of the machine learning, or software emulation) may be reused to process new data. Machine learning may be carried out on data of particularly large volume, i.e. using as much data as possible (e.g. stability, convergence, weak signals, etc.). New data may be continuously added and the learning may be refined.

Various learning algorithms may be used, in combination with the features according to the invention. The method may comprise one or more algorithms among algorithms comprising: support-vector machines (SVM); boosting (classifiers); neural networks (unsupervised learning); decision trees (random forest), statistical methods such as the Gaussian mixture model; logistic regression; linear discriminant analysis; and genetic algorithms.

Machine learning tasks are generally classified into two broad categories, depending on whether a “signal” or learning inputs or “feedback of information” or outputs are available.

The expression “supervised learning” designates a situation in which input examples and (real or desired) output examples are presented to the computer. The learning then consists in identifying a set of rules that makes the inputs correspond to the outputs (these rules may be humanly understandable or not).

The expression “semi-supervised learning” designates a situation in which the computer receives only an incomplete dataset: for example some output data are missing.

The expression “reinforcement learning” designates a paradigm that consists in learning the actions to take, on the basis of experiments, so as to optimize a quantitative reward over time. By way of iterative experiments, a decisional behaviour (called the strategy or policy, which is a function associating the current state with the action to be performed) is determined as being optimal, in that it maximizes the sum of the rewards over time.

The expression “unsupervised learning” (also called deep learning) designates a situation in which no annotation exists (no labels, no description, etc.), leaving the learning algorithm alone to find one or more structures, between inputs and outputs. Unsupervised learning may be an objective in itself (discovery of structures hidden in the data) or a means of achieving an objective (learning by functionalities).

Depending on the embodiment, the human contribution in the machine-learning steps may vary. In certain embodiments, the machine learning is applied to the machine learning itself (reflexive). Specifically, the entirety of the learning process may be automated, in particular if a plurality of models are used and the results produced by these models compared. In most cases, humans participate in machine learning (human in the loop). Developers or curators are responsible for maintaining datasets: data ingestion, data cleaning, model discovery, etc.

The machine learning may correspond to hardware architectures that are emulatable by computer (e.g. CPU-GPU), but sometimes not (there may be circuits dedicated to the learning).

Various learning algorithms may be used. The method may comprise one or more algorithms among the algorithms comprising: support vector machines (SVM); boosting (classifiers); neural networks (in unsupervised learning); decision trees (random forest), statistical methods such as the Gaussian mixture model; logistic regression; linear discriminant analysis; and genetic algorithms.

In hardware terms, depending on the embodiment, the method according to the invention may be implemented using one or more neural networks. A neural network according to the invention may be one or more neural networks chosen among the neural networks comprising: a) an artificial neural network; b) an acyclic artificial neural network, e.g. a multilayer perceptron, that thus differs from a recurrent neural network; c) a feedforward neural network; d) a Hopfield neural network (a discrete-time recurrent neural-network model the matrix of the connections of which is symmetric and zero on the diagonal and the dynamics of which are asynchronous, a single neuron being updated in each unit of time); e) a network of recurrent neurons (said network consisting of interconnected units that interact nonlinearly, there existing at least one cycle in the structure of said network); f) a convolutional neural network (CNN), a type of network of feedforward acyclic artificial neurons achieved by multilayer stacking of perceptrons; or g) a generative adversarial network (GAN), a class of unsupervised learning algorithms.

### Distributed Ledgers or Blockchains

According to the definition given by Wikipedia, a blockchain or distributed ledger (distributed ledger technology or DLT) is a distributed database that is secured using cryptographic techniques. The exchanged transactions are grouped into “blocks” at regular time intervals, in a way secured by cryptography, which form a chain. After having recorded recent transactions, a new block is generated and analyzed. If the block is valid (distributed consensus), the block may be time-stamped and added to the blockchain. Each block is linked to the preceding one by a hash key. Once added to the blockchain, a block can no longer be either modified or deleted, this guaranteeing the authenticity and the security of the network. To form the chain, hash functions and Merkle trees are used. A hash tree consists of a set of independent control sums. Control sums are concatenated in a tree structure. A hash tree makes it possible to be able to verify the integrity of a dataset without necessarily having at one's disposition all of the data at the moment of the verification. The records in a blockchain are protected against falsification or modification by the storage nodes: falsifying a block requires the entire chain to be falsified, so that the total cost becomes prohibitive and guarantees a level of confidence in the non-falsification of the entirety of the blockchain. The transactions are visible to all of the network (discounting pruning).

Time is an important factor in blockchains (notions of broadcasting, propagation, latency, etc.). Distributed consensus by all of the nodes of the network may take a very different amount of time depending on the technologies used. It may be accelerated using various techniques, in particular sidechains, which also increase storage capacity.

In the context of distributed consensus, a blockchain may use a proof-of-work validation. From the mathematical point of view, a proof of work is “difficult to provide but easy to validate”. Proof-based validating systems are generally asymmetric: the computation that is required in return for a service request is expensive for the requester but remains easily verifiable by a third party. Various techniques may be used, in particular hashcash or a client-puzzle e.g. U.S. Pat. No. 7,197,639.

The nodes called “miners” or “mining” nodes are entities the role of which is to supply the network with computational power, in order to allow the decentralized database to be updated. These miners may be remunerated by the distribution of cryptographic tokens. Other compensation methods (in addition or alternatively) make provision for commissions on the transactions. Miners are not always necessary: in the case of private blockchains for example, the participants in the blockchain themselves maintain the distributed database.

A blockchain may be public or private, or have an intermediate form of governance, which may use different barriers to entry (validation by proof of work). A “public” blockchain functions with no trusted third-parties (so-called trustless model), generally with a complex validation by proof of work (e.g. hashcash). A public blockchain generally does not define any other rules than the rules of the code of the protocol and software technology with which it is composed. A “private” blockchain comprises nodes participating in the consensus that are defined in advance then authenticated. Its operating rules may potentially be extrinsic.

Blockchains may be or become programmable using “smart contracts”. Smart contracts are computational protocols or software packages that facilitate, verify and execute the negotiation or execution of a contract. They aim to emulate or get close to the logic of contractual clauses (contract law). Smart contracts are not strictly equivalent to contractual accords. They contribute to making the violation of an accord expensive because they control a reward by way of digital means. They may—or may not—make provision for the intervention of a third party in the contract with a view to monitoring of its execution (for example “oracles” or oracle services). A smart contract is a software code that is stored and executed in/by a blockchain and is triggered by external data that allow it to modify other data, in the blockchain or elsewhere.

The execution of a smart contract is predictable; at the very least, the code and therefore the nature of the computations or tests carried out by this code are known. The code of a smart contract is stored in the blockchain; the smart contract is executed during the validation of the blocks (the computational resources are distributed, this meaning that the execution of a smart contract is safe in itself: the code of the smart contract is replicated at a plurality of nodes of the architecture implementing the blockchain; since it is deterministic, the results of the various executions must be identical. Thus, the code and the execution of the code are safe.

As for any program or computer code, various programming languages are available, with various regulation and security models (a master contract governing other contracts, contracts in cascade, etc.). The forms taken by the smart contracts may be diverse (e.g. services, agents, snippets, scripts, SOA, API, add-ons, plug-ins, extensions, DLC, etc.). The mathematical logic (the decisions taken with respect to the data) may be that of conventional logic, fuzzy logic, combinatorial logic, intuitionistic logic, modal logic, propositional logic, partial logic, paraconsistent logic, etc. or a combination of these types of logic. The software package may be partially or completely coded in hardware form (e.g. FPGA). A smart contract may be entirely or partially open source and/or closed source. In the open-source case, the code is auditable or verifiable by the parties or third parties. A smart contract may combine open-source portions (e.g. portions that are auditable, verifiable, improvable, etc.) with closed-source portions (i.e. portions that are proprietary, secret, sensitive, etc.). A closed source may be a binary code, which may optionally be obfuscated or hardened. The cryptographic techniques used may be diverse: symmetric, asymmetric, post-quantum, quantum-safe, with use of quantum key distribution, etc. A smart contract may be human- and/or machine-readable.

Embodiments of the invention are described below.

In one embodiment, a computer-implemented method for sharing aeronautical data is described, said method comprising steps of maintaining a private blockchain, said private blockchain involving a plurality of predefined parties; in conditionally communicating aeronautical data, in response to a request from one party among the predefined parties, via a predefined mechanism for controlling the exchanges (e.g. coded into the blockchain, for example via one or more smart contracts), the communicated aeronautical data being data collected beforehand from one or more aeronautical computers (e.g. FMS) located on board one or more aircraft of the predefined parties.

In one embodiment, the mechanism for controlling the exchanges comprises access to and/or communication of data of the blockchain in exchange for a remuneration or a compensation, and the mechanism for controlling the exchanges is determined via one or more smart contracts. The term “remuneration” means a sum of money rendered in exchange for work or a service. The term “compensation” designates an operation via which purchases and sales are settled by means of reciprocal transfers, without movement of certificates or money. Compensation for contributions (which tend to reach a steady level e.g. as evaluated over predefined time ranges) may be achieved in kind (e.g. data for data); it is not necessary to make use of sums of fiduciary money. The smart contracts may work in concert (e.g. by construction, intentionally, with systemic control mechanisms, via deterministic decisions, etc.), but sometimes also “adversarially” (e.g. via tenders of services that are compared then selected, “calls to tender”, random or probabilistic decisions, etc.).

In one embodiment, the data of the blockchain are at least partially encrypted and at least one smart contract determines access to the data, in particular via management of encryption keys. Depending on the embodiment: all the data may be plaintext; all the data may be encrypted and/or masked; or the data may be partially plaintext (metadata) and partially encrypted.

In one embodiment, the source code of the mechanism for controlling the exchanges and/or of one or more of the smart contracts is accessible, at least to the predefined parties. In other embodiments, the source codes are partially closed (binary, or obfuscated i.e. in order to discourage or prevent reverse engineering, or even hardened).

In one embodiment, the mechanism for controlling the exchanges comprises determining a financial amount and/or a reputation score associated with each of the predefined parties. Various reputation-managing mechanisms may be employed, in particular management of the “social graph” of the players. If it turns out that the same players always share their data with the same other players, the blockchain may fork, for example automatically (the computational protocol may pre-empt human organizational decisions), transfer prices may be adjusted, etc.

Ownership of the data may be partially or entirely managed via smart contracts. Digital-rights-management (DRM) mechanisms may manage property transfers, license rights, whether exclusive or not, etc. For example, an exclusive licence associated with a higher price to pay will result in metadata indicating the fact that the data are reserved for a determined use and controlling mechanisms (optionally associated with sanctions or penalties) may be implemented. The management of exclusive rights is not contradictory to the use of a blockchain, provided that the exchanges are transparent and the rules of the exchanges are clear and predefined.

In one embodiment, the price of a dataset is set and predefined, or is variable and determined dynamically, for example via auction, or by order-book trading. Other financial mechanisms may be used (including the creation of markets for derivatives of the data; certain players with a view on the value of data of a certain type may take out options, etc.).

In one embodiment, the exchanges of data are controlled, for example, by applying one or more thresholds or threshold ranges, in particular depending on a data upload/download ratio. This approach is quantitative, and may be modulated by more qualitative approaches (whereby the quality of the shared data is evaluated beforehand and/or subsequently, which is possible if downstream controlling mechanisms are sufficiently all-encompassing).

In one embodiment, one or more smart contracts implement exchange rules that ensure FRAND conditions are met i.e. that prices are fair, reasonable and non-discriminatory. All the rules of competition law may generally be encoded into smart contracts, including for example detection and correction of abuse of a dominant position.

In one embodiment, the method furthermore comprises a step consisting in displaying one or more scores associated with one or more predefined parties, a score for example attesting to a surplus or a deficit in uploading or downloading data, or indeed in the number of cumulative uses of the shared datasets.

In one embodiment, the shared aeronautical data are avionic data and/or non-avionic data, originating from open sources.

In one embodiment, the avionic data for example comprise flight parameters, path data, flight-plan data, air-traffic data, flight settings, ECM/EMU engine data, meteorological data, DFRD black-box data, ATC/AOC/AAC data, NOTAM data and/or data relating to the ACD perimeter comprising certified FMS computer data, automatic pilot or AP data, FCC or flight-control commands, IRS/GNSS/ADC positioning-system data, data from ACAS-TCAS, TAWS-GPWS and radar surveillance systems, data from AOF or taxiing systems, data from RMS/RMP radio-communication systems, wireless company communication data, AOC or ATC air-traffic data, management data from maintenance systems, warning systems, engine data, data from air-conditioning systems, landing-gear management data, data relating to actuators, data relating to electrical and/or hydraulic distribution in the aircraft. This information is of demonstrated integrity (demonstrated via “DAL” levels from A to D). They are also verified for use, in order to guarantee the required robustness level. This list of data types is not exhaustive.

The nature of the data implies technical features in terms of reliability. Avionics systems are critical systems (or systems the reliability of which is guaranteed). They are systems the failure of which has consequences that exceed accepted or acceptable limits, and that are therefore feared. A failure may be characterized by the loss of the function in question, or by the production of erroneous data, with or without detection of an error. Depending on the criticalness of the feared consequences, the probability of occurrence must be kept below an acceptability threshold. Thus, the more critical the consequence, the lower the acceptable probability of occurrence must be. For example, in aeronautics, a catastrophic event (multiple deaths) must have a probability of occurrence lower than 10⁻⁹ per hour flown, whereas a major incident (reduction of safety margins and of operational capacity, discomfort or slight injuries) must have a probability of occurrence lower than 10⁻⁵ per hour flown. To achieve these objectives, the architecture of the (critical) avionics system and the design of each component guarantee this probability of occurrence, via guarantees of the failure rate of each piece of equipment (physical failures) and the testing levels (functional and structural test coverage) of software packages. To meet these requirements, a substantial amount of effort must be spent on system design and testing, and the complexity of the processing operations implemented must be limited. In contrast, the failure of a non-critical system, or a system the reliability of which is not guaranteed (“non-avionic” system) has consequences that are judged to be tolerable, non-critical, or even without significant operational impact. The requirements that must be met by the architecture, the physical components or the software processing operations are therefore lower, and, with respect to a critical system, permit more complex processing operations to be employed and less effort to be spent on development and testing. Generally, an avionics system is associated with a lower physical failure rate and a stricter testing regime than a non-avionic system.

In one embodiment, the non-avionic data comprise data from the AISD perimeter, such as data generated by electronic flight bags or EFB, data generated by cabin or IFE systems, and data generated by ground systems.

In one embodiment, the method furthermore comprises one or more steps in which machine learning is applied to data accessible via the blockchain and/or via one or more smart contracts.

In one embodiment, the machine learning is unsupervised. In one embodiment, the machine learning is applied reflexively using various cooperative and/or adversarial machine-learning techniques (the system learns to learn and chooses itself the most effective techniques).

In one embodiment, the machine learning comprises one or more algorithms selected among algorithms comprising: support-vector machines; classifiers; neural networks; decision trees and/or the steps of statistical methods such as a Gaussian mixture model, a logistic regression, a linear discriminant analysis and/or genetic algorithms.

In one embodiment, a smart contract comprises a computer program stored in and/or executed by said blockchain.

A system for sharing aeronautical data is described, said system comprising: a private blockchain maintained by a plurality of predefined and previously authenticated parties, said blockchain being configured to execute one or more smart contracts; one or more aeronautic computers, for example a flight management system or FMS, that are directly associated with the blockchain in read and/or write mode, and/or indirectly associated with the blockchain via one or more smart contracts; said one or more smart contracts being configured to execute compensating mechanisms depending on transactions relating to the datasets exchanged between the predefined parties.

In one embodiment, the compensating mechanism controls financial flows and/or reputation indicators and/or the flows of exchanged data. The controlling mechanisms may make provision for various penalties or sanctions (e.g. account suspension, ejection, etc.); in contrast “rewards” or bonuses or tips or credits or points may be allocated. Human annotations may be used to annotate the datasets, ask questions, request additional data, etc. (all this being traceable).

In one embodiment, the system furthermore comprises a centralized database and/or a so-called secondary blockchain containing the aeronautical data, said data being referenced or indexed in the so-called primary private blockchain. More generally, N blockchains may coexist, independently, or sometimes interdependently, i.e. be linked to one another.

In one embodiment, the system furthermore comprises: one or more neural networks, chosen among neural networks comprising: an artificial neural network; an acyclic artificial neural network; a recurrent neural network; a feedforward neural network; a convolutional neural network; and/or a generative adversarial neural network; said one or more neural networks being emulated using software by a primary or secondary blockchain and/or by one or more smart contracts; and/or being physical circuits the inputs and outputs of which are controllable by said blockchains and/or by one or more smart contracts. Other types of hardware may be used (AI accelerators, AI chips, e.g. adaptive networks, regenerative networks, etc.).

In one embodiment, the encryption is obtained by post-quantum cryptography. This type of encryption allows quantum attacks to be resisted, where appropriate. Thus, data encrypted now will not be able to be decrypted even should sufficiently power quantum computers be developed. Aeronautical data are sensitive data (e.g. security logs) and thus, it may be advantageous to employ this type of cryptography. Homomorphic cryptography may be used (computation, e.g. learning, with encrypted data).

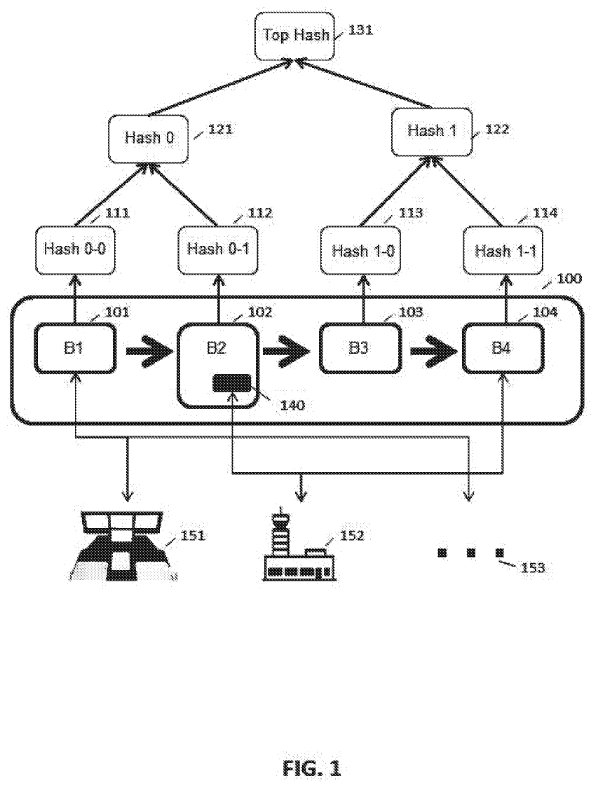

FIG. 1 illustrates one example of a distributed architecture according to the invention.

FIG. 1 shows 4 data blocks B1 to B4 (101, 102, 103, 104). The hash tree consists of a set of interdependent hash values. The leaves of the tree are the hash values of each of the initial data blocks (111, 112, 113, 114). In a (binary) Merkle tree, these hash values are then concatenated pairwise in order to allow a new parent hash (121, 122) to be computed, and so on up to the top of the tree where a top hash (131) is obtained. To guarantee the integrity of a block with respect to all of the data, it is enough to possess the hash values of the brothers, the hash values of the uncles and the top hash. In addition, only the top hash (131) must be reliably obtained to guarantee the integrity of all of the data represented by the tree. For example, if it is desired to verify the integrity of the block B2, it is enough to obtain hash 0-0 (its brother 111), hash 1 (its uncle 122) and the top hash (131).

A data block may comprise one or more codes or programs or smart contracts 140.

Concretely, a smart contract 140 may implement one or more mechanisms: (a) access to the data or some of the data: i) management of access rights and sharing of encryption keys (in the case of an asymmetric encryption the private key is secret and known only to the user but the public key may be obtained from a register); hardware encryption mechanisms may be used (TBM or HSM, chip card, etc.); ii) subscription by unit of time (daily, weekly, monthly, annually, etc.) and/or by volume of data (e.g. Mb of downloaded data); systems of credits or points may be used; b) payment; the transactions may be settled in units of account (crypto-money or fiduciary money e.g. USD or EUR);

The data blocks (101, 102, 103, 104) are produced then consumed, i.e. accessed, in read and/or write mode, by parties or companies (e.g. illustrated by 151, 152, 153).

A party or company or consumer may be the aeroplane manufacturer, an assembler, an OEM, a client or an airline, a maintenance company, a regulating authority, etc.

A party may be a “producer” of data and/or a “consumer” of data. A consumer of data may be referred to as a “client” or “requester” or “receiver” or “buyer” below. A producer may be referred to as a “generator” or “server” or “supplier” or “seller” below. The expression “and/or” highlights the fact that the production and consumption may be successive or alternative, or even simultaneous. As each party may buy and/or sell, license and/or be granted a licence to, cede or gift or share data that it owns, it may also access the data shared by the other parties. The sharing of the data allows other data to be created, certain of which may be of commercial or technical value, inter alia.

For example, the computers 151 located on-board an aircraft consume and produce an extremely large amount of data. Most of the exchanges remain internal to the aircraft, and relate to the general operation of the aircraft. Certain data may become external, i.e. be extracted and stored or transmitted online, for various reasons:

DFDR-Digital Flight Data Recorder: the black box of the craft. Data generated by a number of computers are aggregated in order to determine the events leading up to an incident or accident. The users of these data are generally state-funded bodies responsible for investigating incidents/accidents (in France the relevant body is the Bureau d'Enquêtes et d'Analyses (BEA). It is a legal requirement to provide data to feed the DFDR. The dataset is very small for storage-related reasons.

ECM—Engine Condition Monitoring: the engines of aircraft are very complex, and must be very finely adjusted to optimize them, and particularly monitored to predict problems (predictive maintenance). For these reasons, engine suppliers (engine manufacturers) install engine monitoring units (EMU) in order to concentrate and store information on the engines, this information optionally being transmitted to the ground via digital data links, with a view to analysis thereof. These data may rapidly exceed one Gb (gigabyte) per flight. These data are not transmitted to third parties and are used by the engine manufacturer or by maintenance teams.

AOC-ATC Datalink: operational data may be sent by the communication management units (CMU) to airlines (AOC-airline operation communication; AAC-Airline Administrative Communication) or to the authorities in charge of air traffic control (ATC-Air Traffic Control). These data are limited in amount and relate to the position of the aircraft, its path but also to environmental conditions as sensed by on-board sensors. The data that must be provided are listed in the relevant international standards (AEEC ARINC702 for example as regards AOC data, RTCA D0212/219 as regards ATC data). The data is provided either in a legal context (ATC) or in the context of a contract between the airline on the one hand and the CMU provider or the manufacturer on the other hand.

These data, and a few other, however represent a very small proportion of the raw data generated by on-board computers. Other internal or external data may be shared.

By way of another example of a producer/consumer of data, the authorities in charge of air traffic control 152 rank highly. The data may relate to NOTAM notifications, various warnings, routing statistics or statistics on flight plans, etc.

Lastly, a wide variety of parties 153 may consume or produce useful data: meteorological data, analytics, etc.

An illustration will allow the various levels or layers involved in methods or systems according to the invention to be understood, they are:

a first layer of metadata or blockchain 100; this has the inherent properties of a blockchain (e.g. integrity, un-falsifiability, etc.); the blockchain 100 is essential, the other levels are optional.
a second layer of data 210 which are called or referenced by the blockchain 100 (which is partially or completely encrypted; these data may also comprise uploading metrics, downloading metrics, use metrics, etc. which may determine scores or other quantifications (by means of logical decision-making circuits e.g. computers);
a third intra-player regulating or coordinating layer (the players in turn playing the roles of producer P 201 or consumer C 202, reading and/or writing to the blockchain 100). The accords between participants in the blockchain may be (dumb) written contracts, or partially—or entirely—transcribed via smart contracts of the type referenced by the reference number 140; an optional fourth layer 220 may regulate the smart contracts (linked contracts, independent contracts, master contract modifying other contracts downstream, or in contrast upstream, multiple feedback loops between contracts, feedforward loops, etc.). Optionally, this block 220 may represent one or more validators (or oracles, which may correspond to an independent human and/or machine, i.e. algorithmically encoded, validation).

A high number of embodiments of the invention are possible. A few examples are described below, it being understood that minimal variations should be replaced in the scope of protection sought.

### Private or Public Chains

In one embodiment, the blockchain 100 of aeronautical data is public. In one embodiment, the blockchain of aeronautical data is private: each participant is agreed beforehand (by contract or accord 201-202) and technically has available to him keys or authenticating means.

### Secondary or Side Blockchains

Additionally or alternatively, one or more secondary blockchains (not shown) may be used. For example a primary blockchain may contain metadata relating to the aeronautical data (including the hash values of the data), whereas a secondary chain may contain the data themselves.

### Algorithmic Coding of the Exchanges

To ensure free and undistorted competition, limits or other fool-proofing mechanisms may be coded algorithmically. For example, if there turns out to be only a single supplier of one category of data (e.g. fuel consumption), then automatic mechanisms for adjusting prices or tariffs may be imposed by the smart contracts: “reasonable” prices may be applied, access conditions removed (non-discrimination). Independent rating entities (oracles), agreed by the parties participating in the blockchain, may contribute to the scores and/or to the modes of transaction regulation.

Various remuneration (or compensation or payment) mechanisms may be employed. Various motivational models may be implemented. In certain cases, the mechanisms may be static and predefined. In others, these mechanisms may be dynamic. In certain embodiments, the mechanisms may attempt to ensure the participating players are (a priori) treated equally or that “fair” remuneration is given (the remuneration being noted and/or refined a posteriori).

### Regulation of the Exchanges

The exchanges may be regulated algorithmically i.e. clearly, impartially and in a predefined way, e.g. determination and manipulation of the scores of the participants in the blockchain.

In one embodiment, each participant is associated with one or more scores, which may change over time (e.g. be regularly updated, be updated after each transaction, etc.). In one embodiment, the scores of a party are summarized in a synthetic score (“rank A”, “rank AA”, etc.) that may be a synthetic aggregate of a plurality of criteria (comprising the quantification of the quality of the data sent, for example measured by the number of uses by peers; the sums committed, expended or received, etc.).

In one embodiment, a node or participant in the blockchain is associated with a synthetic score or value score VS which governs access to the exchanges (as a producer and/or consumer of data).

In one embodiment this score VS may depend on i) the “value” of the information that the participant produces VS_PROD and ii) the “value” of the information that the participant consumes VS_CONS. The score VS may be expressed in the form of a (numerical) score, of a symbol, of a value in crypto-money, of an amount of real (fiduciary) money, etc.

The term “value” designates a quantification carried out according to predefined criteria, this quantification aiming to interpret the absolute and/or relative utility of the data shared by the participant. Specifically, the utility may be absolute (certain performance-related data may be rare, or in contrast public and of zero utility e.g. empty weight of the aeroplane), but also relative (data relating to changes in flight-plan levels as a function of ATC centre and of fuel consumption may significantly aid machine-learning processes by multiplying path envelopes, etc.). Extrinsic quantification of the relative value may be difficult or even impossible to establish (depending on the un-controlled context of use in which the subject matter of the invention is implemented/employed), nevertheless any quantification effort may not be in vain and floor estimates may be established, in particular via the market structure in place (the market value of a type of data may reflect its downstream utility).

In one embodiment, a client or consumer purchases, for an amount VS_MONEY, the right to consume (e.g. credits) in order to subsequently be able to consume data (this possibly being useful if he consumes more data than he produces). Another party to the blockchain may convert its value score VS into real money (or into crypto-money), e.g. for uses not covered by the invention. Its VS is then decreased by an amount VS_MONEY. The score VS of a party to the blockchain therefore varies depending on the attractiveness of the data that this party produces and shares. Various quantifying methods, which may optionally be employed in combination, may be used. The criteria may comprise one or more elements comprising: the number of subscribers, the number of downloads and/or uploads of datasets, the results of votes or the scores attributed by one or more consumers, the volume in gigabytes of data shared, etc.

The values VS_PROD (value of the data produced) and VS_CONS (value of the data consumed) may be computed in various ways, in particular taking into account the quantity of the relevant data (volume of data) and/or the quality of the relevant data (e.g. the criticalness of the computer or of the on-board function), a relative value resulting from a supply/demand appraisal (e.g. trading, order-book consensus on a price, proposition, counter offer, acceptance, refusal, negotiation, etc.), the history of use, the market at a given time as conveyed by predefined parameters, minimum and maximum prices, such as for example determined by a decision-making logic circuit that ensure the conditions of FRAND (fair, reasonable and non-discriminatory) access are met, etc. The values or modalities of computation may be set or determined by a smart contract, which may be two-party (accord between two players) or multi-party (accord between N suppliers and M consumers).

In one embodiment, the blockchain may determine (for example in real-time) the score of a party participating in the blockchain. This score, since it is written to the blockchain, benefits from the properties thereof (non-falsifiable value, certain history).

In other embodiments, various meta-analytics or analytics may be determined: history and ranking of the contributors, computation of the risk that false (i.e. simply erroneous) data or malicious data (i.e. intentionally false data intended to weaken or corrupt the machine learning carried out by the third party, etc.) have been injected. The since the blockchain is transparent at least as regards certain data (descriptive meta-data, history of the transactions, etc.) a potentially malicious party will be rapidly determined to be such and ejected from the trusted circle of authenticated parties. In contrast, the transparency of the system, the governance of which is at least partially auditable, encourages interested parties to abandon a certain amount of control over the data, in return for access to third-party data and/or financial compensation.

When a producer publishes one or more data sets in a database 210, by publishing the corresponding hash values in the blockchain 100, the corresponding metadata are added to a block, which is time stamped. The block allows the source to be identified (successful authentication) and provides a guarantee as to the integrity of the supplied data (hash values). When a consumer fetches a dataset from the base 210 associated with the blockchain, the score of the producer is re-evaluated (e.g. addition of a determined sum if the block is validated, subtraction of a sum if the dataset is corrupt or false or empty or otherwise invalid) as is the consumer's own score (for example to reflect an inverse value to that credited to the producer, but various weightings may be applied). This transaction, comprising these credits/debits, identification data, etc., are written to the blockchain. In this way, the parties appear either to be in data-supply credit or in data-supply debt. It is possible for permanent or intermittent debt situations to be acceptable (e.g. compensatable by financial flows): the main thing is for the judgements to be transparent and safe, i.e. traceable and non-falsifiable.

Embodiments with Smart Contracts

In one embodiment, the collaborative sharing module may be based on one or more “smart contracts”, the contract for example making it possible to ensure that the interested parties are treated equally (in value terms). The data are shared in a blockchain in order to ensure the time stamping and immutability.

In one embodiment, all the data of the blocks are written in plaintext (e.g. access rights are protected). In one embodiment, some of the data are written in plaintext (certain information is readable by everybody, other information of higher added value is protected, for example by encryption). In one embodiment, the data of the blocks are encrypted (e.g. symmetric encryption, asymmetric encryption, etc.). In certain cases the data of the blocks are masked in addition to being encrypted (the existence of the data is hidden, this providing additional protection).

In one embodiment, the data are stored in one or more entirely or partially encrypted shared databases, after verification of their integrity and of the authenticity of the producer.

In one embodiment, the produced data are validated by distributed consensus (e.g. use validated with a “relevance” score by a number of consumers, measurement and tracking of the rate of use, etc.) and/or validation by a peer participating in the blockchain and who is recognized as being reliable in the chain (qualification of a technical or administrative nature).

In one embodiment, a few items of information (such as the format and/or a summary of the content of the encrypted block) are left in plaintext in a storage space (in the chain or outside of the chain), in order that an interested consumer be able to determine whether the block is of interest to him or not.

In one embodiment, the use that a consumer desires to make of the data of a block is governed (directly or indirectly via rules) by a smart contract. In other words, a smart contract may comprise one or more digital-rights-management (DRM) mechanisms that may govern the manipulation of the data (e.g. right to read, write, copy, publish, etc.).

In one embodiment, a smart contract may read plaintext data and trigger one or more operations, for example if the client or requester or consumer is validly subscribed to the type of data of the block in question or if predefined conditions have been met.

In certain embodiments, the rights to the data blocks may be conditional on contribution criteria (in particular upload/download or seed/leech ratio).

In one embodiment, access to the data or the rights to these data may be administered conditionally (for example if the balance of the client or his value score is positive).

Where appropriate, if conditional access is granted (or if the predefined conditions are met), the executed smart contract may generate a transaction or request to fetch data, which transaction will be inserted (among a number of others) into a new block. If the distributed consensus confirms the block comprising the transaction, an encryption key allowing the desired data to be read may be sent to the client; who will then be able to read and exploit the desired data.

### Example of Implementation of a Smart Contract

In one embodiment, a supplier fills a database with new data. A smart “supply” contract detects the new data and stores metadata in a blockchain (e.g. identification, date, generator, score, hash of the content of the data, etc.). The data are sold or supplied freely (auction mechanism, first-come first-served mechanism, DRM license mechanism specifying the number of uses, etc.). The price of the data may be determined, using various mechanisms (e.g. calculation of the intrinsic value of the data, for example using one or more preestablished models, computation of their value via creation of a market, e.g. trading and order book, auction, reverse auction, etc.). If an accord on the data and on the price is found between the blockchain (via a smart contract) and a client, then a transaction may be carried out (data for data; data for monetary payment, e.g. fiduciary payment, private payment, units of account, credits internal to the blockchain). A smart “consumption” contract may then be triggered, and for example verify various conditions or criteria (e.g. eligibility, score of the buyer, quantified reputation, access rights, balance, etc.). A smart data “supply” contract may then be triggered and communicate the bought or licensed data to the client—for example, the information of one or more data blocks (e.g. addresses, decryption key, hash values of the content of the data, etc.). The client, once in possession of the desired data may exploit them (for example technically, e.g. in order to improve statistics, enrich or feed machine-learning systems). The uses of the data may, apart from the technical protective measures, be limited juridically (by contract); for example, the client may have the contractual obligation to destroy any copies of the data that he has after a certain date; he may be forbidden by contract to distribute the accessed data, etc.).

In one variant embodiment, a plurality of suppliers share data and store the hash values of the data, and information relating to the format of the data, in one or more blockchains. After a transaction has been carried out, one or more smart contracts verify the value “score” of the buyer, indicate thereto the position of the data in the shared database, and the keys for decrypting the data.

In one variant embodiment, one or more contracts use escrow-payment mechanisms, etc. In particular, the data may be re-encrypted, etc.

Direct Embodiment, without Smart Contracts

In one variant embodiment, the producers and/or consumers may not employ smart contracts, instead reading and/or writing (directly) from/to the blockchain. For example, a producer may receive a buy order from a consumer and, if the transaction completes, may communicate directly with the consumer. Thus, the blockchain does not contain the data themselves but solely a description of the data. This embodiment is advantageous in that the data replicated in the blockchain are significantly less voluminous.

Other embodiments are described below.

### Subscription(s)

In one embodiment, an aircraft may, for example in turn, publish information intended for other members of the network or indeed “subscribe” to the network, for example via a smart contract, and receive information regarding it automatically. For example, an aeroplane may (precisely) safely and integrally share its meteorological information (which is for example non-regulatory, or the conditions encountered locally) with other aircraft (belonging to other airlines). The modes of subscription may comprise push modes and/or pull modes, unsubscription, etc.

### Differential Privacy

Differential privacy is a property of anonymity that may be achieved via various mechanisms. Various mechanisms may decrease the risk of identification of a party or of a confidential datum, if possible by maximizing the relevancy of the results of a given request. These mechanisms comprise k-anonymity, t-closeness, I-diversity or zero-knowledge exchanges. The latter expression designates a secure protocol in which an entity called the “proof provider”, mathematically proves to another entity that a proposition is true without however revealing any information other than the veracity of the proposition. In certain embodiments, zero-knowledge sharing mechanisms may be employed. An aeroplane fleet of a company A may thus communicate security logs (e.g. attempted cyber-attacks) with other flights or with other airlines, without it being possible for critical information to be uncovered by an attacker even were he to manages to gain access to the data (e.g. in addition to protection by encryption, obsolescence, validity intervals, criticality levels; etc.).

Embodiments with External Validation

In one embodiment, an intermediary is added: a data validator (not shown). In a first step, of production, a source decides to publish data in the blockchain (directly or indirectly via the base 210). The data are sent with an identifier (that allows the source sending the data to be identified) and a summary of the contents (e.g. parameters, units, amount, format, etc.) and the date (e.g. of creation, of validity, etc.) of the data. This set forms a “block” to be validated. The validation subsystem receives the data. The validation is carried out either by consensus or by a “trusted” external “validator”: other suppliers or users verify the integrity of the data (and optionally the authenticity of the generator). This may give rise to remuneration (in VS) of the one or more nodes that participated in the validation. It may be the consumer that verifies the integrity of the block (hash). In one embodiment, the consumer may “score” (unilaterally) the attractiveness of the received block (his interest as estimated for and by himself). In one embodiment, the score is given by the consumer. In one embodiment, the score is computed by counting the number of times that the data set in question has been downloaded and/or the number of interested consumers or buyers/current licensed users. If the data are declared to be invalid then the blockchain is updated, with the VS_PROD of the producer being decreased by a certain amount, and the VS_PROD of the party who detected the anomaly being increased by a certain amount. In one embodiment, if the data are considered to be valid/integral, then a new block, which will contain the link to the data (e.g. addresses, keys) is created, and the VS_PROD of the validating party or node is increased by a certain amount.

Embodiments with Internal Validation

In certain embodiments, the validating third-party is internalized: the verifications are carried out directly and automatically by one or more smart contracts. On each new input into the base (and on each new attempt to write a block) one or more smart contracts may execute various tasks, in particular a) verify whether the producer has been declared (whether it is a question of a party to the consortium or blockchain); b) modify score VS of the source c) note or evaluate the input data (directly or indirectly); optionally d) directly carry out functional verifications on the data (for example, data generated by an aircraft of model X may be correlated/cross-correlated with other sources of information on the aircraft (e.g. public or private sources of the company, of air-traffic control) generated in real-time and corresponding to the state of the aircraft (e.g. time of takeoff, current status e.g. in flight, on the ground, cruising, current position, etc.).

With a view to consuming data, a consumer subscribes to receive or declares that he is interested in receiving data (e.g. buy order made directly to the blockchain or via a smart contract). The smart contract in question may verify whether the buyer has a sufficient balance (VS) to download the data. In one variant embodiment, the bought block is supplied to one or more human and/or machine validators that perform this verification. If the transaction is valid, the (for example encrypted) dataset is transmitted to the buyer, who may for example have the option of verifying its integrity (hash value fetched from the blockchain). If the dataset is determined or reputed to be valid, decryption keys (stored in the blockchain) are fetched by the smart contract and transmitted to the buyer. The transaction is then written to the blockchain by the smart contract. In one embodiment, compensating and/or evaluating and/or remunerating and/or validating mechanisms may be implemented if the data are determined to be valid (scoring and/or reputation-based mechanism for identifying or remunerating the generators of the most “useful” data (“useful” being a notion relating to one or more objectives that may be objectified and internalized). The requesting consumer i.e. the initiator of the transaction may for example import the obtained data and cross-correlate or integrate them with existing data with the aim of carrying out processing of the “big data” type using artificial-intelligence techniques (in particular machine learning).

In the aeronautical context, the consumer may for example use the predicted arrival times at crossing points, and the actual crossing times obtained from the flight management system (FMS) or computer of a set of aeroplanes that are travelling a path that it is following, to make correlations as to the probable airport arrival time in light of events that it also gathers, via this data-sharing mechanism, via a blockchain (e.g. weather as measured by air data units, ATC settings of the CMU computer, path actually followed by the aircraft (as given by GPS computers), automatic pilot, information on traffic density obtained from TCAS computers, etc.).

Software and/or Hardware Implementation

In hardware terms, embodiments of the invention may be implemented by computer. For example, a distributed architecture of the cloud-computing type may be used. Peer-to-peer servers that are entirely or partially distributed (existence of centres) may interact. Blockchains are based on a decentralized architecture, which may be relatively distributed. The implementation of a blockchain is no obstacle to the existence of one or more privileged nodes, when it is a question of a private cloud or of a private blockchain. Access may be multiplatform (e.g. from EFB, WebApp, ground access, etc.). One or more EFB may interact with one or more FMS.

In one embodiment, an aircraft is equipped with a module for communicating and collaboratively sharing data output from computers located on-board the aircraft. This hardware module is in communication with various users and/or suppliers of data. In one embodiment, the method is computer-implemented. The computer may be a rack or a tablet or an EFB or a software package integrated into the FMS, etc.

The present invention may be implemented using hardware and/or software components. It may be made available as a computer-program product on a computer-readable medium. The medium may be electronic, magnetic, optical, or electromagnetic.

1. A computer-implemented method for sharing aeronautical data, comprising the steps of: maintaining a private blockchain, said private blockchain involving a plurality of predefined parties;
conditionally communicating aeronautical data, in response to a request by one party among said predefined parties, via a predefined mechanism for controlling the exchanges, the aeronautical data communicated being data collected beforehand from one or more aeronautical computers located on board one or more aircraft of the predefined parties.

2. The method according to claim 1, the mechanism for controlling the exchanges comprising access to and/or communication of data of the blockchain in exchange for a remuneration or a compensation, and the mechanism for controlling the exchanges being determined by one or more smart contracts.

3. The method according to claim 2, the data of the blockchain being at least partially encrypted and at least one smart contract determining the access to the data, in particular via management of encryption keys.

4. The method according to claim 1, the source code of the mechanism for controlling the exchanges and/or of one or more of the smart contracts being accessible, at least to the predefined parties.

5. The method according to claim 1, the mechanism for controlling the exchanges comprising determining a financial amount and/or a reputation score associated with each of the predefined parties.

6. The method according to claim 5, the price of a dataset being set and predefined, or being variable and determined dynamically, for example via auction, or via order-book trading.

7. The method according to claim 1, the data exchanges being controlled, for example capped, by applying one or more thresholds or ranges of thresholds, in particular depending on a data upload/download ratio.

8. The method according to claim 1, one or more smart contracts implementing exchange rules that ensure FRAND conditions are met i.e. that prices are fair, reasonable and non-discriminatory.

9. The method according to claim 1, furthermore comprising a step consisting in displaying one or more scores associated with one or more predefined parties, a score for example attesting to a surplus or a deficit in uploading or downloading data, or indeed in the number of cumulative uses of the shared datasets.

10. The method according to claim 1, the shared aeronautical data being avionic data and/or non-avionic data, originating from open sources.

11. The method according to claim 10, the avionic data for example comprising flight parameters, path data, flight-plan data, air-traffic data, flight settings, ECM/EMU engine data, meteorological data, DFRD black-box data, ATC/AOC/AAC data, NOTAM data and/or data relating to the ACD perimeter comprising certified FMS computer data, automatic pilot or AP data, FCC or flight-control commands, IRS/GNSS/ADC positioning-system data, data from ACAS-TCAS, TAWS-GPWS and radar surveillance systems, data from AOF or taxiing systems, data from RMS/RMP radio-communication systems, wireless company communication data, AOC or ATC air-traffic data management data from maintenance systems, warning systems, engine data, data from air-conditioning systems, landing-gear management data, data relating to actuators, data relating to electrical and/or hydraulic distribution in the aircraft.

12. The method according to claim 11, the non-avionic data comprising data from the AISD perimeter, such as data generated by electronic flight bags or EFB, data generated by cabin or IFE systems, and data generated by ground systems.

13. The method according to claim 1, furthermore comprising one or more steps wherein machine learning is applied to data accessible via the blockchain and/or via one or more smart contracts.

14. The method according to claim 13, the machine learning being unsupervised, or being applied reflexively using various cooperative and/or adversarial machine-learning techniques.

15. The method according to claim 13, the machine learning comprising one or more algorithms selected among algorithms comprising: support-vector machines; classifiers; neural networks; decision trees and/or the steps of statistical methods such as a Gaussian mixture model, a logistic regression, a linear discriminant analysis and/or genetic algorithms.

16. The method according to claim 2, a smart contract comprising a computer program stored in and/or executed by said blockchain.

17. A system for sharing aeronautical data, comprising:
a private blockchain maintained by a plurality of predefined and previously authenticated parties, said blockchain being configured to execute one or more smart contracts;
one or more aeronautic computers, for example a flight management system or FMS, that are directly associated with the blockchain in read and/or write mode, and/or indirectly associated with the blockchain via one or more smart contracts;
said one or more smart contracts being configured to execute compensating mechanisms depending on transactions relating to the datasets exchanged between the predefined parties.

18. The system according to claim 17, the compensating mechanism controlling financial flows and/or reputation indicators and/or the flows of exchanged data.

19. The system according to claim 18, furthermore comprising a centralized database and/or a so-called secondary blockchain containing the aeronautical data, said data being referenced or indexed in the so-called primary private blockchain.

20. The system according to claim 17, furthermore comprising:
one or more neural networks, chosen among neural networks comprising: an artificial neural network; an acyclic artificial neural network; a recurrent neural network; a feedforward neural network; a convolutional neural network; and/or a generative adversarial neural network;
said one or more neural networks being emulated using software by a primary or secondary blockchain and/or by one or more smart contracts; and/or
being physical circuits the inputs and outputs of which are controllable by said blockchains and/or by one or more smart contracts.
